(19) United States
(12) Patent Application Publication
(10) Pub. No.: US 2009/0315488 A1
(43) Pub. Date: Dec. 24, 2009

(54) METHOD AND SYSTEM FOR PROVIDING DIFFERENT VIBRATION OUTPUTS

(75) Inventors: HER-CHING SHYU, Tu-Cheng (TW); YUN-LONG SIE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/261,051

(22) Filed: Oct. 30, 2008

(30) Foreign Application Priority Data
Jun. 19, 2008 (CN) 200810302220.4

(51) Int. Cl. H02P 31/00

(52) U.S. Cl. 318/114

(57) ABSTRACT

A method and system for providing different vibration outputs in an electronic device having a vibrator are provided. The method includes assigning different intensity parameters to a plurality of pitches, selecting a music file comprising a plurality of musical notes, acquiring the pitch and duration for each musical notes of a selected music file and associating the corresponding intensity parameters to the respective pitches, and controlling the intensity and duration of the vibrator according to the intensity parameters and duration derived from the acquiring step.

### BACKGROUND

1. Field of the Invention

Embodiments of the present disclosure relate to vibration output, and more particularly to a method and a system for providing different vibration outputs on a portable electronic device.

2. Description of Related Art

Currently, mechanical vibrators are employed in typical electronic devices for a variety of purposes. Mobile phones and pagers utilize the mechanical vibrators to provide a vibrating notification for replacing ringing tones of incoming calls or messages. In addition, in a noisy environment, users may enable the ringing tones and the vibrators at the same time to avoid missing the calls.

However, typical vibrators are usually driven with a fixed frequency allowing only monotone vibration and such monotone vibration provides poor tactile feedback.

Accordingly, a method and a system for providing different vibration outputs on a portable electronic device are called for in order to overcome the limitations described.

### SUMMARY

A method for providing different vibration outputs in an electronic device having a vibrator is provided. The method includes assigning different intensity parameters to a plurality of pitches, selecting a music file comprising a plurality of musical notes, acquiring the pitch and duration for each musical notes of a selected music file and associating the corresponding intensity parameters to the respective pitches, and controlling the intensity and duration of the vibrator according to the intensity parameters and duration derived from the acquiring step.

Other advantages and novel features of the present method and system for providing different vibration outputs will become more apparent from the following detailed description of certain inventive embodiments when taken in conjunction with the accompanying drawings.

### BRIEF DESCRIPTION OF THE DRAWINGS

FIG. 1 is a block diagram of an embodiment of a system for providing different vibration outputs;

FIG. 2 shows one example of corresponding intensity parameters of musical notes that may be defined by a music module;

FIG. 3 shows one example of corresponding intensity parameters and duration of the vibrations that may be defined by a vibration module;

FIG. 4 is a flowchart of an embodiment of a method for providing different vibration outputs.

### DETAILED DESCRIPTION OF CERTAIN INVENTIVE EMBODIMENTS

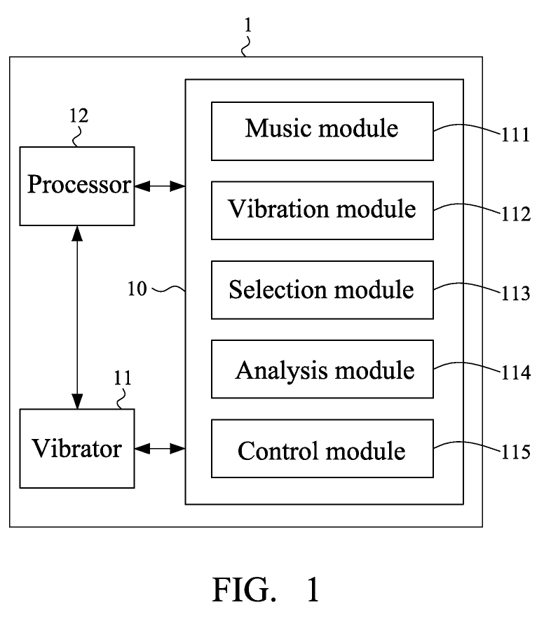

FIG. 1 is a block diagram of an embodiment of a system 10 for providing different vibration outputs (hereinafter “the system 10”). An electronic device 1, such as a mobile phone, includes a vibrator 11, and the system 10, and a processor 12 for executing the system 10 to control the vibrator 11. Portable and non-portable electronic devices other than the mobile phone shown here, such as notebook computers and personal digital assistants (PDAs), for example, may equally utilize the system 10, without departing from the spirit of the disclosure.

In one embodiment, the system 10 includes a music module 111, a vibration module 112, a selection module 113, an analysis module 114 and a control module 115, in addition to other hardware and software components of the electronic device 1. All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

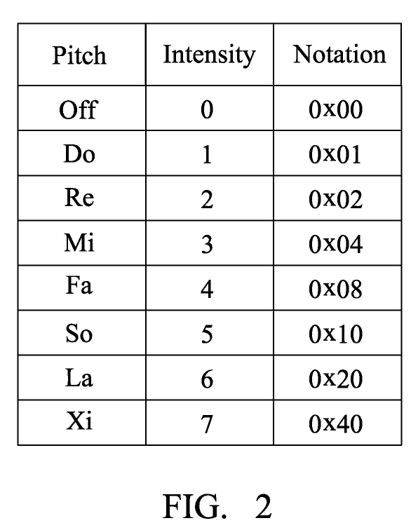

The music module 111 is configured for assigning intensity parameters to a plurality of pitches. As shown in FIG. 2, different intensity parameters, ranging from 0 to 7, are assigned to the plurality of pitches, although the disclosure is not limited thereto. In the above-mentioned example, the intensity parameter “0” stands for the weakest intensity, such as no vibration, and intensity parameter “7” stands for the strongest intensity. In addition, the music module 111 also defines a set of notations corresponding to the intensity parameters. For example, the intensity parameter “0” is stored as “0x00” and the intensity parameter “7” is stored as “0x40.”

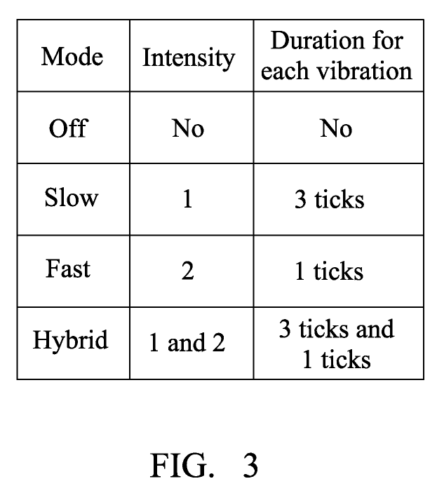

The vibration module 112 is configured for defining a plurality of vibration modes. In one embodiment, as shown in FIG. 3, the vibration modes includes: “Off-vibration,” “Slow-vibration,” “Fast-vibration” and “Hybrid-vibration,” although the disclosure is not limited thereto. The vibration module 112 is also configured for defining corresponding intensity parameters and duration of each vibrations for each vibration modes. For example, in the “Hybrid-vibration” mode, the vibrator 11 is configured to vibrate with intensity parameter “1” for 3 ticks and with intensity parameter “2” for 1 ticks successively.

The selection module 113 is configured for selecting music files or vibration modes. The music files may be encoded in a Music Instrument Digital Interface (MIDI) format, a Moving Picture Experts Group Audio Layer III (MP3) format, a Windows Media Audio (WMA) format, or an Advanced Streaming Format (ASF) format, but the disclosure is not limited there.

The analysis module 114 is configured for acquiring the pitch and duration for each musical notes of a selected music file, and then associating the musical notes with corresponding intensity parameters according to rules defined by the intensity module 111. The associated intensity parameter and duration for each musical notes are then utilized for conducting a vibration by the vibrator 11. The analysis module 114 is also configured for acquiring the intensity parameters and duration of each vibrations for a selected vibration mode defined by the vibration module 112. For example, if the selected music file is encoded in the MP3 format, the analysis module 114 acquires the pitch and duration for each musical notes of the selected MP3 music file, and then associates the corresponding intensity parameters to the respective musical notes.

The control module 115 is configured for controlling the intensity of the vibrator 11 according to the intensity parameters and duration retrieved from the analysis module 114.

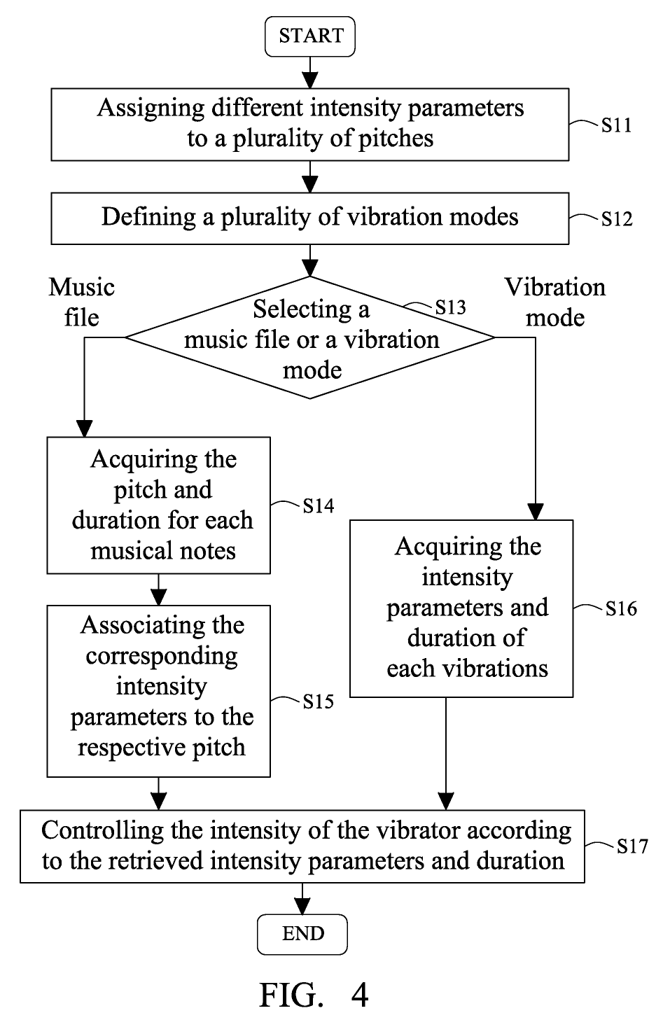

FIG. 4 is a flowchart of an embodiment of a method for providing different vibration outputs. The method of FIG. 4 may used for controlling a vibrator 11 installed in the electronic device 1 with different intensity parameters and duration. Depending on the embodiment, additional blocks may be added or deleted and the blocks may be executed in order other than that described.

In block S11, the music module 111 assigns different intensity parameters to a plurality of musical notes. In block S12, the vibration module 112 defines a plurality of vibration modes and corresponding intensity parameters and duration of each vibration for the vibration modes. As mentioned previously, the vibration modes includes: “Off-vibration,” “Slow-vibration,” “Fast-vibration” and “Hybrid-vibration,” although the disclosure is not limited thereto.

In block S13, the selection module 113 selects a music file or a vibration mode. If one music file is selected, in block S14, the analysis module 114 acquires the pitch and duration for each musical notes of the selected music file. In block S15, the analysis module 114 associates the corresponding intensity parameters to the respective pitch. In block S17, the control module 115 controls the intensity of the vibrator 11 according to the intensity parameters and duration of the vibration retrieved from the analysis module 114.

If one of the vibration mode is selected in block S13, in block S16, the analysis module 114 acquires the intensity parameters and duration of each vibrations for the selected vibration mode. In block S17, the control module 115 controls the intensity of the vibrator 11 according to the intensity parameters and duration of the vibration retrieved from the analysis module 114.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A computing system for providing different vibration outputs, the system comprising:
a vibrator;
a music module for assigning intensity parameters to a plurality of pitches;
a selection module for selecting a music file;
an analysis module for acquiring a pitch and a duration for each musical note of the selected music file and for associating the pitches with corresponding intensity parameters;
a control module for controlling the intensity and the duration of the vibrator according to the intensity parameters and the duration retrieved from the analysis module; and
a processor for executing the music module, the selection module, the analysis module and the control module.

2. The system as claimed in claim 1, wherein the system further comprises a vibration module configured for defining a plurality of vibration modes.

3. The system as claimed in claim 2, wherein the vibration module is further configured for defining corresponding intensity parameters and duration of each vibration for each vibration mode.

4. The system as claimed in claim 3, wherein the selection module is configured for selecting a vibration mode.

5. The system as claimed in claim 4, wherein the analysis module is configured for acquiring the intensity parameters and duration of each vibrations for the selected vibration mode.

6. The system as claimed in claim 5, wherein the vibration modes comprise an off-vibration mode, a slow-vibration mode, a fast-vibration mode, and a hybrid-vibration mode.

7. The system as claimed in claim 1, wherein the music module is configured for defining a set of notations corresponding to the intensity parameters.

8. The system as claimed in claim 1, wherein the music files are encoded in a format selected from the group consisting of: MIDI, MP3, WMA, and ASF.

9. A computer-implemented method for providing different vibration outputs in an electronic device comprising a vibrator, the method comprising:
a defining step for assigning different intensity parameters to a plurality of pitches;
a selecting step for selecting a music file comprising a plurality of musical notes;
an acquiring step for acquiring a pitch and a duration for each musical note of a selected music file, and associating the corresponding intensity parameters to the respective pitches; and
a control step for controlling the intensity and duration of the vibrator according to the intensity parameters and duration derived from the acquiring step.

10. The method as claimed in claim 9, wherein the defining step further comprising:
defining a plurality of vibration modes; and
defining corresponding intensity parameters and duration of each vibrations for each vibration mode.

11. The method as claimed in claim 10, wherein the selecting step further comprising:
selecting a vibration mode.

12. The method as claimed in claim 11, wherein the acquiring step further comprising:
acquiring the intensity parameters and duration of each vibrations for the selected vibration mode.

13. The method as claimed in claim 12, wherein the vibration modes comprise an off-vibration mode, a slow-vibration mode, a fast-vibration mode, and a hybrid-vibration mode.

14. The method as claimed in claim 9, wherein the music files are encoded in a format selected from the group consisting of: MIDI, MP3, WMA, and ASF.
